(19) United States
(12) Patent Application Publication
(10) Pub. No.: US 2002/0058519 A1
(43) Pub. Date: May 16, 2002

(54) Information providing system, output terminal, mobile terminal, and storage medium

(75) Inventor: Atsushi Nagahara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 09/983,487

(22) Filed: Oct. 24, 2001

(30) Foreign Application Priority Data
Oct. 26, 2000 (JP) 2000-327788

(51) Int. Cl. H04Q 7/20

(52) U.S. Cl. 455/456; 455/414

(57) ABSTRACT

To provide an information providing system which is appropriate for delivering, to a user at a destination of a travel of the user, information much needed by the user, of information relating to the area of the destination. A content delivery terminal 300 includes a user information registration DB 40 which registers user information, and a content registration DB 42 which registers digital contents. Upon receiving a content delivery request, the content delivery terminal 300 receives position information of a mobile terminal 100 from a relay station 210, searches for a digital content in the content registration DB 42 based on the received position information and the user information in the user profile table 500, and prints out the retrieved digital content on an output terminal PR.

### BACKGROUND OF THE INVENTION

1. Field of Invention

The present invention relates to a system, an output terminal, a mobile terminal, and a storage medium for providing a user of a mobile terminal with information and, more particularly, to an information providing system, an output terminal, a mobile terminal, and a storage medium storing an information providing program, appropriate for providing the user with information, much needed by the user, out of information relating to a destination area of a travel, for example.

2. Description of Related Art

Japanese Unexamined Patent Application Publication No. 10-185599 discloses an information providing system as a system for providing an information to a user of a mobile terminal such as a mobile telephone or a PDA (Personal Digital Assistant).

This system includes a processing terminal and a GPS server. The processing terminal acquires position information from a GPS (Global Positioning System) at the position acquisition unit thereof, organizes the position information in a store-and forward switching type information package such as an electronic mail, and sends the package to the GPS server. The GPS server corrects the position information to high precision, relatively measured information using WADGPS, collects information desired by the user, from a vast amount of information over a network according to the position information, packages the desired information into an electronic mail, and sends the electronic mail to the user. Upon receiving the electronic mail at a receiver unit, the user decompresses the packaged information at the output unit of the processing terminal. Since this arrangement frees the processing terminal from the workload of correcting the position information and of collecting information, the processing terminal with compact and mobile designs implemented therewithin allows the user to obtain information desired by himself.

The above-described conventional information providing system collects information desired by the user, from a vast amount of information over a network, in accordance with the position information of the mobile terminal, and provides the collected information to the user. For example, the user now wants to visit notable sights in Tokyo. When the user enters “notable sights” as a keyword, a GPS server provides the user with information relating to the notable sights in Tokyo.

However, in the above example, the number of the sights in Tokyo is large, and a great deal of duplicated or similar information is included in the information of the sights in Tokyo. The user may have difficulty in monitoring and studying the sights when such a large amount of information is presented. The user may be interested in some of the sights, but not interested in other sights. For example, a user, who is interested in seeing temples and shrines, has no interest in information about amusement parks, even if that information is related to the sights in Tokyo.

The present invention has been developed in view of the above unresolved problem of the conventional art, and it is an object of the present invention to provide an information providing system, an output terminal, a mobile terminal, and a storage medium storing an information providing program, appropriate for providing the user with information, much needed by the user, out of information relating to a destination area of a travel, for example.

### SUMMARY OF THE INVENTION

To achieve the above object, an information providing system of the present invention as recited in claim 1, communicably connected to a mobile terminal, for providing a user of the mobile terminal with information, includes user information storage means for storing user information relating to the user, data information storage means for storing data information to be provided, position information acquisition means for acquiring position information determining a position of the mobile terminal, and data information selection means for selecting the data information in the data information storage means, based on the user information in the user information storage means and the position information acquired by the position information acquisition means.

In this arrangement, when the information providing system is communicably connected to the mobile terminal, the position information acquisition means acquires the position information of the mobile terminal, and the data information selection means selects the data information in the data information storage means based on the user information in the user information storage means and the acquired position information. The selected data information is displayed on the mobile terminal or is printed out on printer means such as a printer.

The user information contains, for example, the age, sex, interest and preference, and the address of a user. The data information is now selected based on the user information and the position information, and the user information now includes age information. When the user is a relatively aged person, information intended for the aged people may be selected from information relating to an area determined by the position information. When the user information includes sex information, information intended for women may be selected from information relating to an area determined by the position information if the user is a woman. When the user information includes interest and preference, information matching the interest and preference of the user may be selected from the information relating to an area determined by the position information. When the user information includes the address, information relating to the area in which the address is located is selected from the information of an area determined by the position information. The same is true of an information providing system according to one of claims 2, 3, and 4, an output terminal of claim 10, a mobile terminal of claim 11, and a storage medium of claim 12 storing an information providing program.

The selected data information may be displayed on the mobile terminal by sending the selected data information to the mobile terminal. The selected data information may be printed out on printer means by outputting the selected data information to the printer means. The selected data information may be displayed or printed on the other terminal by sending the selected data information to the other terminal (such as a personal computer owned by the user, or a personal computer installed on a store near the user's location) which may be accessed by the user of the mobile terminal. The same is true of the information providing system of one of claims 2, 3, and 4.

The user information storage means stores the user information by any means and at any time. The user information storage means may store beforehand the user information, or may store the user information in response to inputting from the outside at the startup of the system without storing beforehand the user information. In that sense, the same is true of the mobile terminal of claim 11.

The data information storage means stores the data information by any means and at any time. The data information storage means may store beforehand the data information, or may store the data information in response to inputting from the outside at the startup of the system without storing beforehand the data information. In that sense, the same is true of the information providing system of one of claims 2 and 3.

The position information acquisition means may acquire the position information by measuring the position of the mobile terminal with a communication terminal to which the mobile terminal is communicably connected. Alternatively, the position information acquisition means may acquire the position information by measuring the position of the mobile terminal using the GPS, or by calculating the position of the mobile terminal with the communication terminal based on measurement information from the mobile terminal. Alternatively, the position of the mobile terminal may be measured at a base station to which the mobile terminal is connected. Furthermore, the position information may be acquired by causing the communication terminal to calculate the position based on measurement information from a base station. The same is true of the information providing system of claim 2 and a storage medium of claim 12 storing an information providing program.

The information providing system may be implemented in a single apparatus, or a network system to which a plurality of terminals is communicably connected. In the latter case, components of each system may be located in any of the plurality of terminals as long as the components are communicably connected to each other. The same is true of the information providing system of one of claims 2, 3, and 4.

An information providing system of the present invention as recited in claim 2, communicably connected to a mobile terminal containing user information storage means for storing user information relating to a user, provides the user of the mobile terminal with information when the user information is received from the mobile terminal. The information providing system includes data information storage means for storing data information to be provided, position information acquisition means for acquiring position information determining a position of the mobile terminal, and data information selection means for selecting the data information in the data information storage means, based on the user information from the mobile terminal and the position information acquired by the position information acquisition means.

In this arrangement, the user information in the user information storage means in the mobile terminal is transmitted to the information providing system. When the information providing system, communicably connected to the mobile terminal, receives the user information, the position information acquisition means acquires the position information of the mobile terminal. The data information selection means selects the data information in the data information storage means based on the received user information and acquired position information. The selected data information may be displayed on the mobile terminal or may be printed out on the printer means such as a printer.

An information providing system of the present invention as recited in claim 3, communicably connected to a mobile terminal containing user information storage means for storing user information relating to a user and position information acquisition means for acquiring position information determining a position of the mobile terminal, provides the user of the mobile terminal with information when the user information and the position information are received from the mobile terminal. The information providing system includes data information storage means for storing data information to be provided, and data information selection means for selecting the data information in the data information storage means, based on the user information and the position information from the mobile terminal.

In this arrangement, the position information acquisition means in the mobile terminal acquires the position information of the mobile terminal, and the user information in the user information storage means and the acquired position information are sent to the information providing system. When the information providing system, communicably connected to the mobile terminal, receives the user information and the position information, the data information selection means selects the data information in the data information storage means based on the received user information and position information. The selected data information may be displayed on the mobile terminal or may be printed out on the printer means such as a printer.

An information providing system of the present invention as recited in claim 4, is communicably connected to a mobile terminal containing user information storage means for storing user information relating to a user and position information acquisition means for acquiring position information determining a position of the mobile terminal, and is also communicably connected to a information storage terminal containing data information storage means for storing a plurality of pieces of data information to be provided. The information providing system provides the user of the mobile terminal with information when the user information and the position information are received from the mobile terminal. The information providing system includes data information selection means for selecting the data information in the data information storage means, through communication with the information storage terminal based on the user information and the position information from the mobile terminal.

In this arrangement, the position information acquisition means in the mobile terminal acquires the position information of the mobile terminal, and the user information in the user information storage means and the acquired position information are sent to the information providing system. When the information providing system, communicably connected to the mobile terminal, receives the user information and the position information, the data information selection means communicates with the information storage terminal based on the user information and the position information. In accordance with the user information and the position information, the information storage terminal selects the data information in the data information storage means, and then the selected data information is sent to the information providing system. Upon receiving the data information, the information providing system displays the received data information on the mobile terminal or prints out the received data information on the printer means such as a printer.

To achieve the above object, the basic construction of the information providing system has been proposed. Alternatively, to achieve the above object, the following first and second information providing systems are contemplated.

A first information providing system, is communicably connected to a mobile terminal containing user information storage means for storing user information relating to a user, and is also communicably connected to a information storage terminal containing data information storage means for storing a plurality of pieces of data information to be provided. The first information providing system provides the user of the mobile terminal with information when the user information is received from the mobile terminal. The first information providing system includes position information acquisition means for acquiring position information determining the position of the mobile terminal, and data information selection means for selecting the data information in the data information storage means, through communication with the information storage terminal based on the user information from the mobile terminal and the position information acquired by the position information acquisition means.

In this arrangement, the user information is transmitted from the user information storage means in the mobile terminal to the information providing system. When the information providing system, communicably connected to the mobile terminal, receives the user information, the position information acquisition means acquires the position information of the mobile terminal. The data information selection means communicates with the information storage terminal based on the received user information and the acquired position information. The information storage means selects the data information in the data information storage means based on the user information and the position information, and the selected data information is sent to the information providing system. Upon receiving the data information, the information providing system displays the received data information on the mobile terminal or prints out the received data information on the printer means such as a printer, for example.

The position information acquisition means is identical to that stated in claim 1.

A second information providing system, is communicably connected to a mobile terminal, and is also communicably connected to a information storage terminal containing data information storage means for storing a plurality of pieces of data information to be provided. The second information providing system provides the user of the mobile terminal with information. The second information providing system includes user information storage means for storing user information relating to the user, position information acquisition means for acquiring position information determining a position of the mobile terminal, and data information selection means for selecting the data information in the data information storage means, through communication with the information storage terminal based on the user information in the user information storage means and the position information acquired by the position information acquisition means.

In this arrangement, with the information providing system communicably connected to the mobile terminal, the position information acquisition means acquires the position information of the mobile terminal. The data information selection means communicates with the information storage terminal based on the user information in the user information storage means and the acquired position information. The information storage terminal selects the data information in the data information storage means based on the user information and the position information. The selected data information is sent to the information providing system. Upon receiving the data information, the information providing system displays the received data information on the mobile terminal or prints out the received data information on the printer means such as a printer, for example.

The user information storage means and the position information acquisition means are respectively identical to those stated in claim 1.

An information providing system of the present invention as recited in claim 5, according to one of claims 1 through 4, communicably connected to a plurality of output terminals for outputting data information, includes output terminal selection means for selecting, from among the plurality of output terminals, an output terminal from which the user most appropriately receives the data information, and data information transmitter means for transmitting the data information, selected by the data information selection means, to the output terminal selected by the output terminal selection means.

With this arrangement, in the information providing system, the output terminal selection means selects, from among the plurality of output terminals, the output terminal from which the user most appropriately receives the data information, and the data information transmitter means transmits the data information, selected by the data information selection means, to the output terminal selected by the output terminal selection means. Upon receiving the data information, the output terminal outputs the data information.

The output terminal from which the user most appropriately receives the data information may be an output terminal which is closest to the position of the mobile terminal in terms of distance or time required to go, an output terminal which is closest to the destination of the user of the mobile terminal in terms of distance or time required to go, an output terminal from which the user can receive the data information the most quickly because of a data rate of the output terminal, or an output terminal from which the user obtains the data information with a minimum cost.

In an information providing system of the present invention as recited in claim 6, according to claim 5, the output terminal selection means selects, from among the plurality of output terminals, the output terminal from which the user most appropriately receives the data information, based on at least one of the user information and the position information.

In this arrangement, the output terminal selection means selects, from among the plurality of output terminals, the output terminal from which the user most appropriately receives the data information, based on at least one of the user information and the position information.

The output terminal selection means selects the output terminal based on the user information only, or based on the position information only, or based on both of the user information and the position information.

In information providing system of the present invention as recited in claim 7, according to one of claims 1 through 6, the data information is a digital content, and the information providing system includes content layout means for determining an output layout of a digital content which is selected by the data information selection means in accordance with the user information, and for laying out the digital content in accordance with the output layout.

When the data information selection means selects the digital content in this arrangement, the content layout means determines the output layout of the selected digital content and lays out the digital content in accordance with the output layout.

The output layout includes a display layout according to which the digital content is displayed on a screen, and a print layout according to which the digital content is printed on a sheet of paper.

In an information providing system of the present invention as recited in claim 8, according to claim 1, the user information storage means includes first user information storage means for storing the user information that requires confidentiality, and second user information storage means for storing the rest of the user information, and the mobile terminal includes the first user information storage means.

In this arrangement, the user information in the first user information storage means in the mobile terminal is transmitted to the information providing system. When the information providing system, communicably connected to the mobile terminal, receives the user information, the position information acquisition means acquires the position information of the mobile terminal, and the data information selection means selects the data information in the data information storage means based on the received user information, the user information in the second user information storage means, and the acquired position information.

To achieve the above object, an output terminal of the present invention as recited in claim 9, is communicably connected to the information providing system according to one of claims 5 and 6, wherein the output terminal holds information relating to a delivery request by the mobile terminal, of the data information received from the information providing system, without outputting the information relating to the delivery request, until the mobile terminal enters a predetermined area, and outputs the information relating to the delivery request by the mobile terminal, of the data information received from the information providing system, when the mobile terminal enters the predetermined area.

In this arrangement, the output terminal holds information relating to the delivery request by the mobile terminal, out of the data information received from the information providing system, without outputting the information relating to the delivery request, until the mobile terminal enters a predetermined area. The output terminals outputs the information relating to the delivery request by the mobile terminal, out of the data information received from the information providing system, when the mobile terminal enters the predetermined area.

In an output terminal of the present invention as recited in claim 10, according to the information providing system as recited in claim 9, the data information transmitter means transmits the data information selected, by the data information selection means, and the user information, to the output terminal selected by the output terminal selection means, the output terminal includes first user information receiver means for receiving the data information and the user information from the information providing system, and second user information receiver means for receiving the user information from the mobile terminal, and when the second user information receiver means receives the user information, the user information received by the first user information receiver means is matched against the user information received by the second user information receiver means, and when these pieces of user information satisfy a predetermined relationship, the data information received by the first user information receiver means is output.

When the second user information receiver means receives user information from the mobile information in this arrangement, the user information received from the information providing system by the first user information receiver means is matched against the user information received by the second user information receiver means. When these pieces of user information satisfy the predetermined relationship, the data information received by the first user information receiver means is output.

Satisfying the predetermined relationship means that first user information to be checked coincides with second user information, that the result that is obtained by subjecting the first user information to calculation based on a predetermined equation coincides with the second user information, or that the result that is obtained by subjecting the first user information to calculation based on a predetermined equation coincides with the result that is obtained by subjecting the second user information to calculation based on a predetermined equation.

To achieve the above object, a mobile terminal of the present invention as recited in claim 11, communicably connected to an information providing system according to one of claims 2 and 3, includes user information storage means for storing the user information relating to the user with security information associated with the user information, and transmission mode determining means for determining a transmission mode of the user information based on the security information in the user information storage means.

In this arrangement, the transmission mode determining means determines the transmission mode of the user information based on the security information in the user information storage means when the user information is transmitted from the user information storage means to the information providing system.

The following transmission modes are contemplated. For example, the transmission mode determining means queries the user of whether to transmit the user information before the user information at a relatively high security level is transmitted. The transmission mode determining means notifies the user of the content of the user information to be transmitted before the data information at a standard security level is transmitted. When the data information at a relatively low security level is transmitted, the user information is directly transmitted without checking with the user.

To achieve the above object, as recited in claim 12, a computer readable storage medium, communicably connected to a mobile terminal, storing an information providing software program provides a user of the mobile terminal with information, wherein the software program for a process carried out by position information acquisition means for acquiring position information determining a position of the mobile terminal, and data information selection means for selecting data information in the data information storage means, based on the user information in the user information storage means, and the position information acquired by the position information acquisition means, is performed by a computer including user information storage means for storing user information relating to the user, and data information storage means for storing the data information to be provided.

In this arrangement, the computer reads the data information providing software program stored in the storage medium, and the computer executes processes in accordance with the read software program. The storage medium of claim 12 thus provides the same advantages as those of the information providing system recited in claim 1.

### BRIEF DESCRIPTION OF THE DRAWINGS

FIG. 1 is a block diagram showing the construction of a network system implementing the present invention;

FIG. 2 is a block diagram showing the construction of a content delivery terminal 300;

FIG. 3 shows the data structure of a user profile table 500;

FIG. 4 shows a layout definition file and the data structure of a layout definition table 530;

FIG. 5 is a flow diagram showing a user registration process;

FIG. 6 is a flow diagram showing a content delivery process;

FIG. 7 is a block diagram showing the construction of an output terminal PR,;

FIG. 8 is a flow diagram showing a content reception process; and

FIG. 9 is a flow diagram showing a content printing process.

### DETAILED DESCRIPTION OF PREFERRED EMBODIMENTS

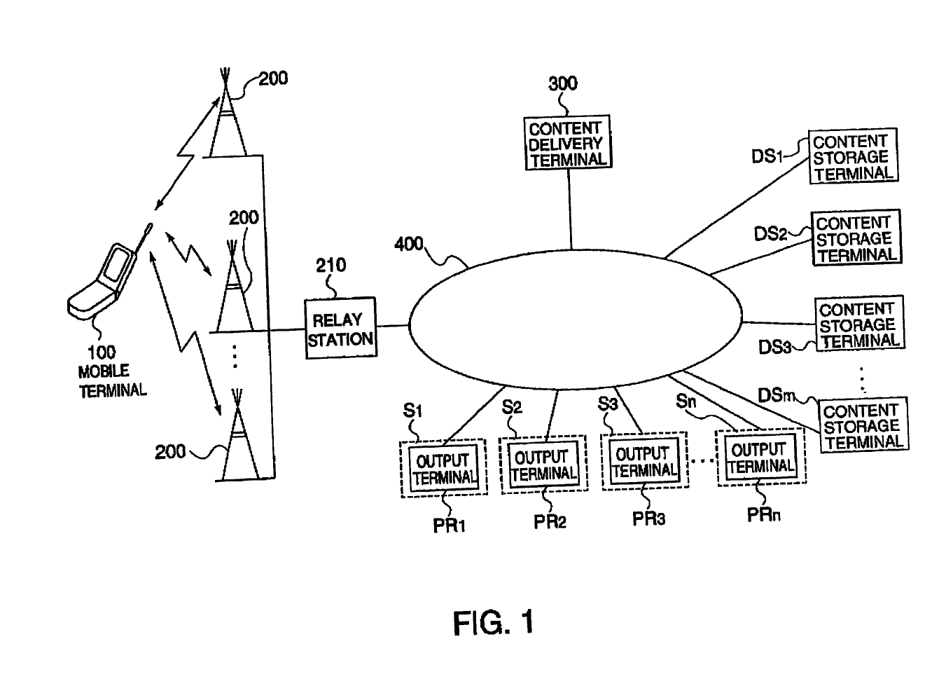

The embodiments of the present invention will now be discussed, referring to the drawings. FIG. 1 through FIG. 9 show the embodiments of an information providing system, an output terminal, a mobile terminal, and a storage medium of the present invention.

In this embodiment, the information providing system, the output terminal, the mobile terminal, and the storage medium of the present invention are arranged as shown in FIG. 1. A content delivery terminal 300 is communicably connected, through the Internet 400, to a mobile terminal 100 such as a mobile telephone owned by a user and output terminals PR₁-PRₙ respectively installed at a plurality of stores S₁-Sₙ distributed at various locations. The content delivery terminal 300 selects a digital content from among digital contents acquired from content storage terminals DS₁-DSₘ in response to a content delivery request from a user, and outputs the selected digital content to an appropriate one of the output terminals PR₁-PRₙ. Although a single mobile terminal 100 is shown for simplicity, a plurality of different mobile terminal 100 can be actually connected to the Internet 400.

The construction of a network system implementing the present invention will now be discussed, referring to FIG. 1. FIG. 1 is a block diagram showing the construction of the network system of the present invention.

Connected to the Internet 400 as shown in FIG. 1 are a relay station 210 for relaying communication between the mobile terminal 100 and the Internet 400, the plurality of content storage terminals DS₁-DSₘ for storing digital contents, the content delivery terminal 300 which collects and stores the digital contents from the plurality of content storage terminals DS₁-DSₘ and then provides the user with the digital contents, and the output terminals PR₁-PRₙ for printing out the digital contents thereon.

A plurality of base stations 200 for performing radio communications with the mobile terminal 100 is connected to the relay station 210. When the mobile terminal 100 is connected to the Internet 400, the relay station 210 works for the mobile terminal 100 as one terminal over the Internet 400. The relay station 210 sends data, which is received from the mobile terminal 100 via the base station 200, to a destination terminal over the Internet 400, while sending data from any target terminal existing over the Internet 400 to the mobile terminal 100 via the base station 200. The mobile terminal 100 concurrently communicates with at least three base stations 200, and the relay station 210 measures durations of time radiowave required to reach the respective base stations 200 from the mobile terminal 100, and measures the position of the mobile terminal 100 based on the measured time differences between the durations of time.

Each of the content storage terminals DS₁-DSₘ, having the same function of a typically available computer, is composed of a CPU, an ROM, an RAM, and an I/F, all of these interconnected through a bus. Each of the content storage terminals DS₁-DSₘ includes a storage unit for storing the digital content, and a request processing unit for sending a digital content in the storage unit to a terminal in response to a request from that terminal, connected to the Internet 400, such as the relay station 210 and the content delivery terminal 300. The digital content in the storage unit includes category information designating a category of a digital content, and area information designating an area associated with the digital content. As will be discussed later, these pieces of information are used when the user searches for a digital content relating to the interest or preference of the user, or when the user searches for a digital content relating to an area of the current location of the user or relating to an area of destination of the user.

The mobile terminal 100, having the same function of a typically available mobile terminal or a PDA, is composed of a CPU, an ROM, an RAM, and an I/F, all of these interconnected through a bus. The mobile terminal 100 is also equipped with a communication software program equivalent to a WWW browser, and accesses the content delivery terminal 300 using the communication software program. The mobile terminal 100 stores a user ID and a password, which are issued when a user registration is performed with the content delivery terminal 300. When the user accesses the content delivery terminal 300 to receive the digital content, for example, the mobile terminal 100 sends the stored user ID and password to the content delivery terminal 300 for automatic authentication.

Furthermore, the mobile terminal 100 includes a short range radio communication device for performing short range radio communication. The short range radio communication device intermittently transmits a request for reply. Upon receiving a reply, the mobile terminal 100 checks that the replay has been received from one of the output terminals PR₁-PRₙ and then transmits the stored user ID and password to the output terminal RP which has replied.

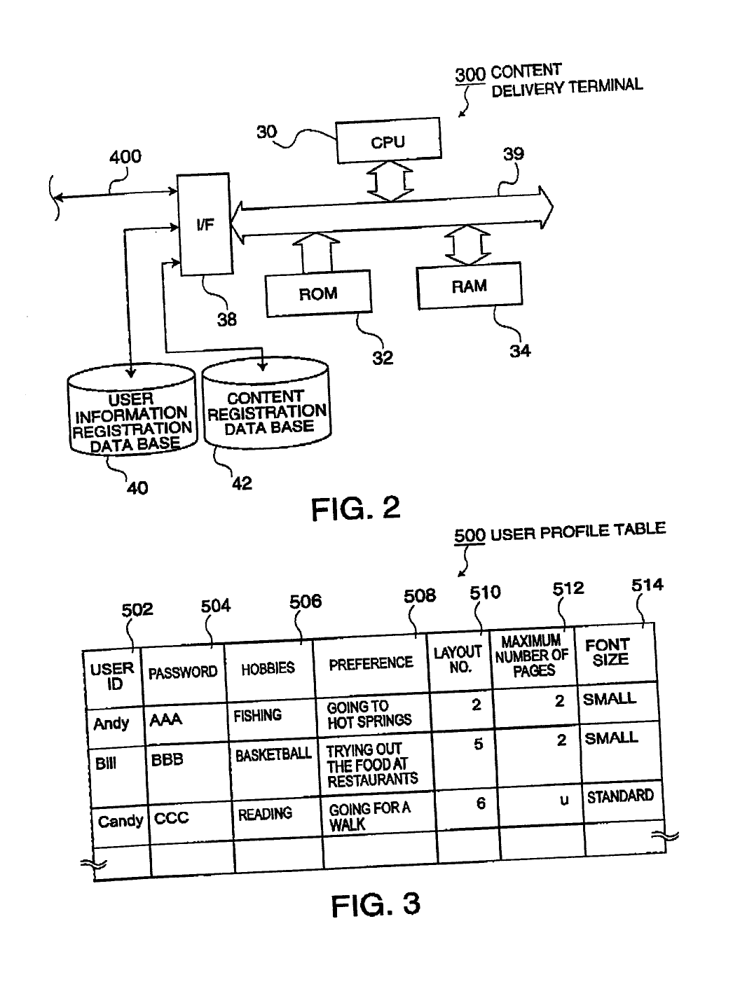

The construction of the content delivery terminal 300 will now be discussed, referring to FIG. 2. FIG. 2 is a block diagram showing the construction of the content delivery terminal 300.

Referring to FIG. 2, the content delivery terminal 300 includes a CPU 30 for performing arithmetic operation and controlling the entire system in accordance with a control program, an ROM 32 for storing beforehand the control program of the CPU 30 in a predetermined area thereof, an RAM 34 for storing data read from the ROM 32 or the like and calculation results required in the course of the arithmetic operation of the CPU 30, and an I/F 38 for interfacing with an external device for exchange of data. To exchange data, these components are mutually interconnected via a bus 39, as a signal line for transferring data.

Connected to the I/F 38 are, as external units, a user information registration data base 40 (data base hereinafter simply referred to as “DB”) for registering user information, a content registration DB 42, for storing digital contents supplied by the content storage terminals DS₁-DSₘ, and a signal line connected to the Internet 400.

Referring to FIG. 3, the user information registration DB 40 stores a user profile table 500 in which the user information is registered. FIG. 3 shows a data structure of the user profile table 500.

The user profile table 500 registers a single record for each user as shown in FIG. 3. Each record includes a field 502 for registering a user ID for identifying a user, a field 504 for registering a password required to perform user authentication process, a field 506 for registering hobby information about hobbies of the user, a field 508 for registering preference information about preference of the user, a field 510 for registering a layout number, a field 512 for registering the maximum number of pages, and a field 514 for registering a font size.

The field 506 registers the hobby information about the hobbies designated by the user. Referring to FIG. 3, the field 506 lists “FISHING” in a first row thereof, “BASKETBALL” in a second row thereof, and “READING” in a third row thereof.

The field 508 registers the preference information about preference designated by the user. Referring to FIG. 3, the field 508 lists “GOING TO HOT SPRINGS” in a first row thereof, “TRYING OUT THE FOOD AT RESTAURANTS” in a second row, and “GOING FOR A WALK” in a third row.

The field 510 registers the layout number for identifying the output layout of the digital content. The layout number identifies the output layout desired by the user. Referring to FIG. 3, layout number 2 is registered in a first row of the field 510, and layout number 5 is registered in a second row of the field 510. The layout number will be discussed in detail later.

The field 512 registers the maximum number of pages at the upper limit when the digital content is printed out. The maximum number of pages designates the maximum numbers of pages at the upper limit. Alternatively, the letter “u” may be designated to set no upper limit. Referring to FIG. 3, “2” pages are registered in a first row of the field 512, and the letter “u” is registered in a third row of the field 512.

The field 514 registers the size of a font when the digital content is printed out. Referring to FIG. 3, a “SMALL” font is registered in a first row of the field 514, and a “STANDARD” font is registered in a third row of the field 514.

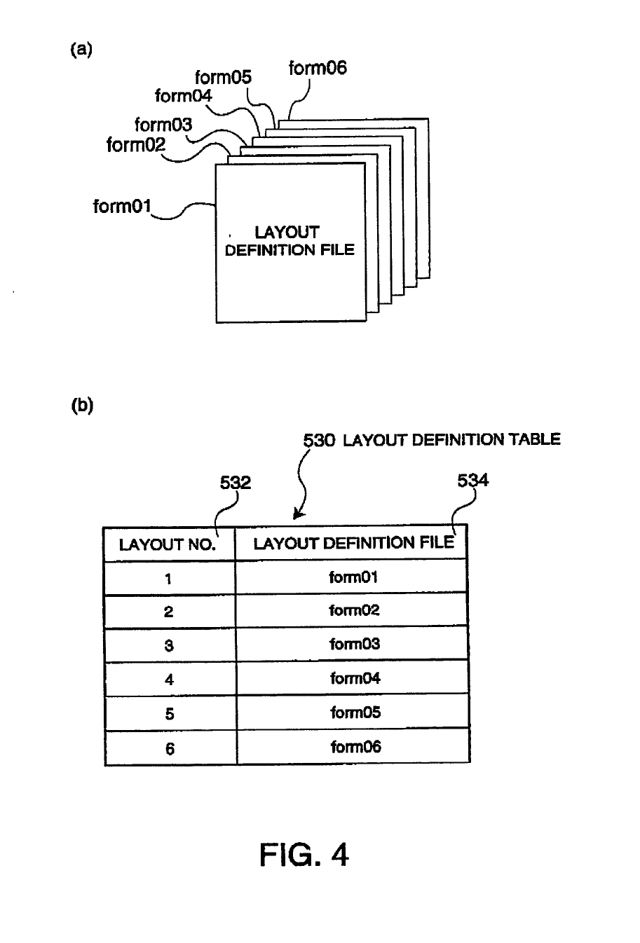

Referring to FIG. 4, the user information registration DB 40 stores a plurality of layout definition files form01-form06 defining the output layout of the digital contents, and a layout number definition table 530 for indicating the correspondence between the layout definition files form01-form06 and the layout numbers. FIG. 4 shows a data structure of the layout definition file and the layout number definition table 530.

Referring to FIG. 4(b), the layout number definition table 530 registers a single record for each layout number. Each record includes a field 532 for registering the layout number, and a field 534 for registering a file name of the layout definition file. As shown in FIG. 4(b), a first record registers “1” as a layout number, and “form0” as a layout definition file name, and a second record registers “2” as a layout number and “form02” as a layout definition file name.

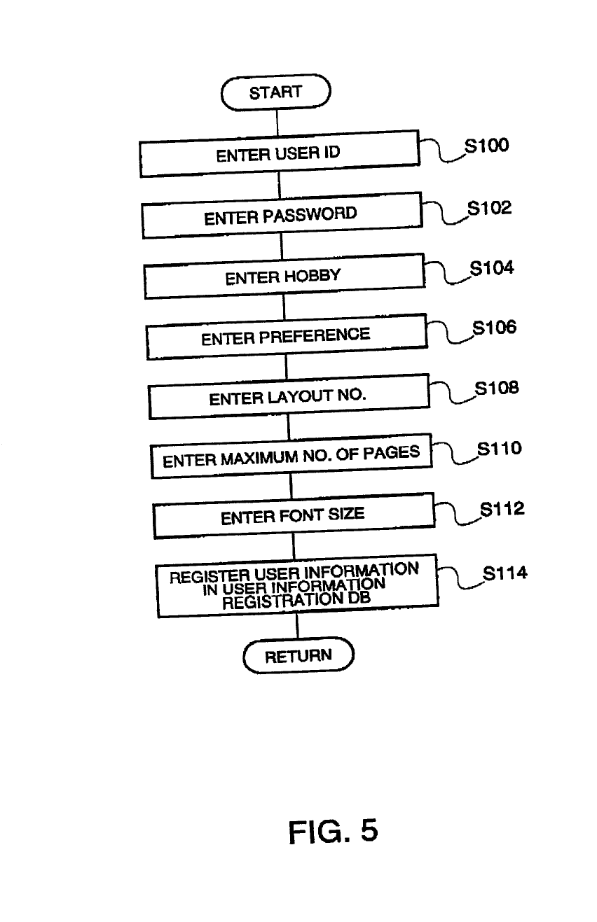

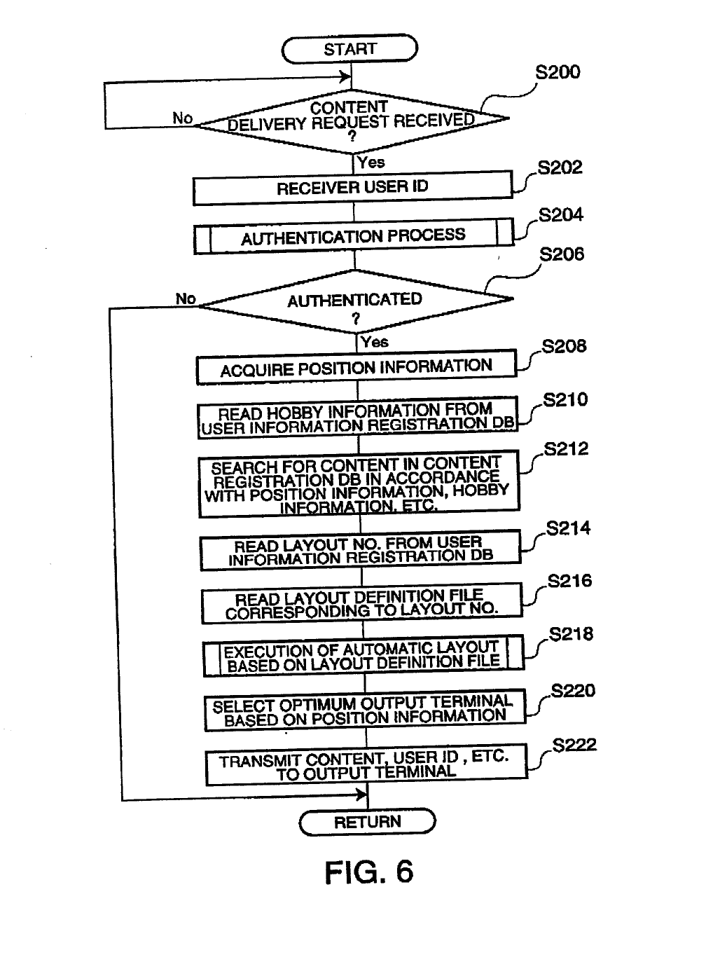

The construction of the CPU 30 and the process executed by the CPU 30 will be discussed referring to FIG. 5 and FIG. 6.

The CPU 30, composed of a micro processing unit MPU, starts a predetermined program stored in a predetermined area of the ROM 32, and executes a user registration process and a content delivery process in a time sharing manner as shown in flow diagrams in FIG. 5 and FIG. 6.

Referring to FIG. 5, the user registration process will first be discussed in detail. FIG. 5 is a flow diagram showing the user registration process.

When the user has accessed the system, the user registration process requests the user to input the user information such as the user ID, and registers the input user information in the user profile table 500. When the CPU 30 starts, the process goes to step S100 as shown in FIG. 5. Inputting in each of the following steps is performed in an interactive communication with the user.

In step S100, the user ID is input. In step S102, the password is input. In step S104, the hobby of the user is input. In step S106, the preference of the user is input, and the process proceeds to step S108.

In step S108, the layout number is input, and in step S110, the maximum number of pages is input. In step S112, a font size is input. In step S114, the user information input in steps S100 through S112 is registered in the user profile table 500, and a series of steps are completed, and the process returns.

The content delivery process will now be discussed in more detail referring to FIG. 6. FIG. 6 is a flow diagram showing the content delivery process.

The content delivery process delivers the digital content to the user by referencing the user profile table 500. Referring to FIG. 6, the CPU 30 starts over with step S200.

In step S200, the CPU 30 determines whether a content delivery request for requesting to deliver a digital content has been received from the mobile terminal 100. If the CPU 30 determines that the content delivery request has been received from the mobile terminal 100 (Yes), the process proceeds to step S202, else (No) the CPU 30 stays in step S200 until the content delivery request is received.

In step S202, the user ID and the password are received from the mobile terminal 100. In step S204, the CPU 30 performs a user authentication process to authenticate the user identity and password by matching the received user ID and password against the user ID and password in the user profile table 500. In step S206, the CPU 30 determines whether the user authentication process authenticates the user identity. When the CPU 30 determines that the user is authenticated (Yes), the process proceeds to step S208.

In step S208, the CPU 30 acquires the position information determining the present position of the mobile terminal 100 via the relay station 210. In step S210, the CPU 30 reads the hobby information and the preference information from the user profile table 500. In step S212, CPU 30 searches for a digital content in the content registration DB 42 based on the acquired position information, and the read hobby information and preference information, and thus retrieves digital contents relating to the present position, and the hobby and preference of the user.

The searching according to the position information searches for the area information attached to the digital content, based on the position information, and identifies the digital content relating to the area of the present position of the user or the destination of the user. The searching according to the hobby information and the preference information searches for the category information attached to the digital content based on the hobby information and the preference information, and identifies the digital content relating to the hobby and preference of the user. The method of searching for the digital content is not limited to the manner in which the digital content matching all of the position information, the hobby information, and the preference information is searched. Alternatively, a digital content having the highest degree of match with one of the position information, the hobby information, and the preference information may be searched for.

In step S214, the CPU 30 reads the layout number from the user profile table 500, and proceeds to step S216. Referencing the layout number definition table 530, the CPU 30 reads, from the user information registration DB 40, the layout definition file corresponding to the read layout number. In step S218, based on the read layout definition file, the CPU 30 performs an automatic layout process in which the output layout is determined for the digital content found in step S212 and the found digital content is laid out in accordance with the determined output layout. The process then proceeds to step S220.

In step S220, the output terminal PR, which is considered appropriate for the user to receive the digital content therefrom, is selected from among the output terminals PR₁-PRₙ based on the acquired position information. Specifically, the CPU 30 selects an output terminal PR which is closest to the position of the mobile terminal 100 in terms of distance or time required to go, an output terminal PR which is closest to the destination of the user of the mobile terminal 100 in terms of distance or time required to go, an output terminal PR from which the user can most quickly receive the data information because of a data rate thereof, or an output terminal PR from which the user obtains the data information with a minimum cost. Any of these selection methods may be set beforehand, or may be set to the user's own preference at the content delivery request or at the user registration.

In step S222, the retrieved digital content, and the received user ID and password are transmitted to the selected output terminal PR, and the process returns.

When it is determined in step S206 that the user is not authenticated (No), a series of steps are completed and the process returns.

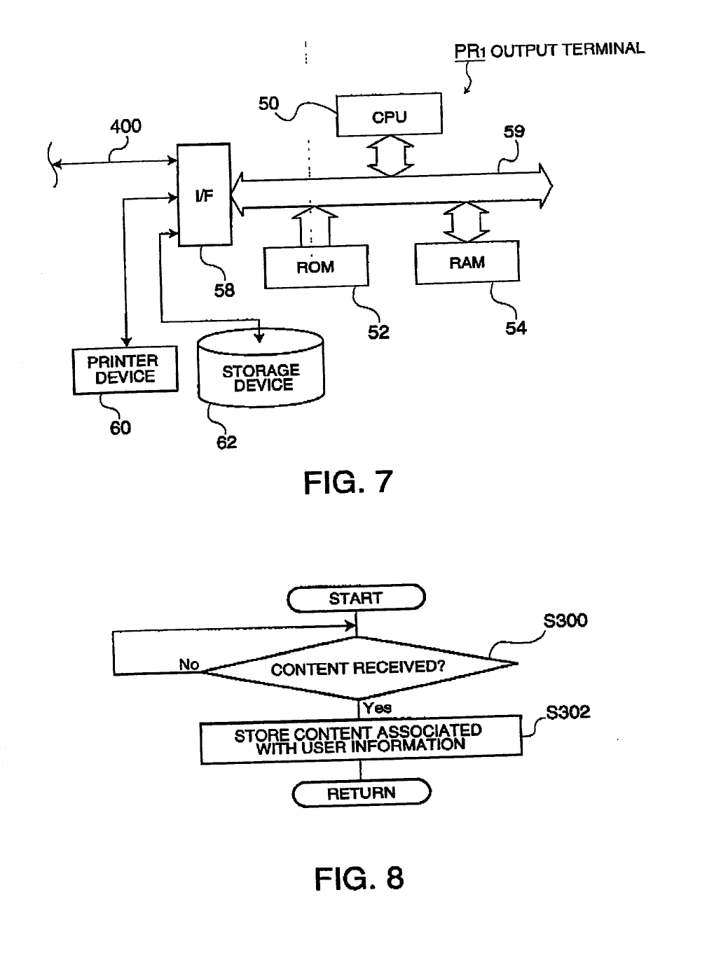

The construction of each of the output terminals PR₁-PRₙ will now be discussed, referring to FIG. 7. FIG. 7 is a block diagram showing the construction of the output terminal PR₁. Since the output terminals PR₁-PRₙ are identical in construction, only the output terminal PR, is discussed and the discussion of the remaining output terminals is skipped.

Referring to FIG. 7, the output terminal PR, includes a CPU 50 for performing arithmetic operation and controlling the entire system in accordance with a control program, an ROM 52 for storing beforehand the control program of the CPU 50 in a predetermined area thereof, an RAM 54 for storing data read from the ROM 52 or the like and calculation results required in the course of the arithmetic operation of the CPU 50, and an I/F 58 for interfacing with an external device for exchange of data. To exchange data, these components are mutually interconnected a bus 59, as a signal line for transferring data.

Connected to the I/F 58 are, as external units, a printer device 60 and a storage unit 62 for storing data and table as a file, and a signal line connected to the Internet 400.

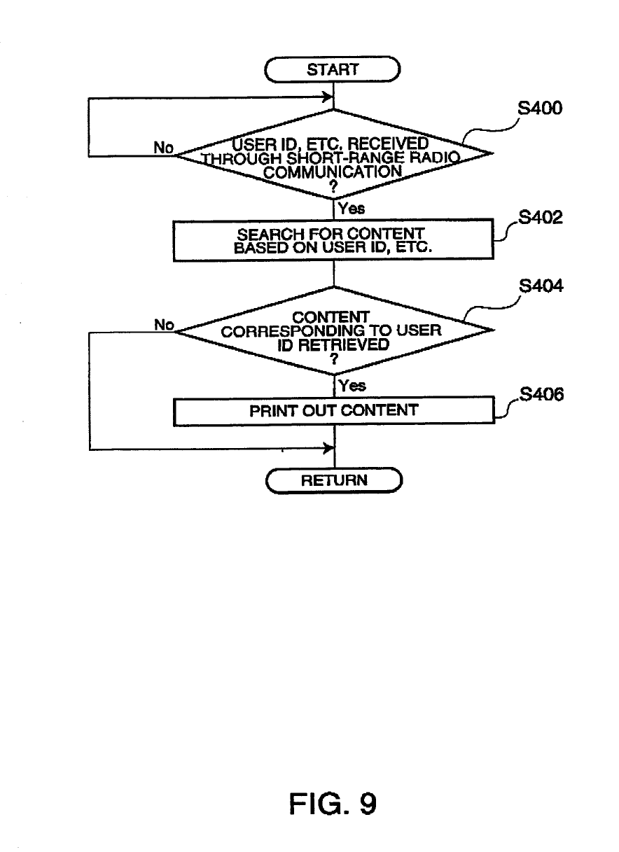

The CPU 50, composed of a micro processing unit (an MPU), starts a predetermined program stored in a predetermined area of the ROM 52, and executes a content receiving process and a content delivery process in a time sharing manner as shown in flow diagrams in FIG. 8 and FIG. 9.

Referring to FIG. 8, the content receiving process will be detailed. FIG. 8 is a flow diagram of the content receiving process.

When the content receiving process for receiving and storing the digital content transmitted from the content delivery terminal 300 is executed by the CPU 50, the process starts over with step S300 as shown in FIG. 8.

The CPU 50 determines in step S300 whether the digital content, the user ID and the password have been received from the content delivery terminal 300. If the CPU 50 determines that the digital content, the user ID and the password have been received (Yes), the process proceeds to step S302, else (No) the CPU 50 stays in step S300 until the digital content, the user ID and the password are received.

In step S302, the received digital content is stored in the storage unit 62 with the received user ID and password associated with the received digital content. A series of steps are completed and the process then returns.

A content printing process will now be discussed, referring to FIG. 9. FIG. 9 is a flow diagram describing the content printing process.

In the content printing process, the digital content requested by the user, out of the digital contents in the storage unit 62, is printed out, when the user enters a predetermined area (for example, within a radius of 10 m of the output terminal PR₁). When being executed by the CPU 50, the content printing process starts over with step S400 as shown in FIG. 9.

In step S400, the CPU 50 determines whether the user ID and password have been received through short-range radio communication from the mobile terminal 100. If the CPU 50 determines that the user ID and password have been received (Yes), the process proceeds to step S402, else (No) the CPU 50 stays in step S400 until the user ID and password are received.

In step S402, the CPU 50 searches for digital contents in the storage unit 62, based on the received user ID and password. In step S404, the CPU 50 determines whether a digital content corresponding to the received user ID and password is found. If the CPU 50 determines that the digital content corresponding to the received user ID and password is found (Yes), the process proceeds to step S406. In steps S402 and S404, the user ID and password are searched for in the storage unit 62 based on the received user ID and password. If the user ID and password corresponding to the received user ID and password are present in the storage unit 62, the digital content corresponding to the user ID and password is retrieved as a requested digital content.

In step S406, the retrieved digital content is output to the printer device 40 for printing. A series of steps are completed and the process then returns.

When it is determined in step S404 that the digital content corresponding to the received user ID and password is not found (No), a series of steps are completed and the process returns.

The operation of the above embodiment will now be discussed.

Now, information required to request a digital content is registered as below.

When the user desires the delivery of digital contents, the user accesses the content delivery terminal 300 using a communication software program on the mobile terminal 100, and inputs a user registration request.

When the user registration request is entered, the mobile terminal 100 receives, through communications with the content delivery terminal 300, screen forming data for forming a user ID entry screen, and presents the user ID entry screen based on the screen forming data.

The user then enters a desired user ID, a desired password, the hobby of the user, the preference of the user, a layout number of a desired output layout, the maximum number of pages, and a font size.

The user enters the user ID and the password by inputting numerals and characters in corresponding text boxes using a keyboard, etc. The user's hobby and preference may be entered by selecting a desired one in a listing of hobbies and preferences registered in a combo box or by inputting a character string in a text box. The layout number is entered by selecting one from a plurality of option buttons corresponding to sample images laid out in accordance with the output layouts. The maximum number of pages is entered by selecting one of five option buttons respectively corresponding to the settings of “2 PAGES,” “4 PAGES,” “6 PAGES,”, “8 PAGES,” and “NO UPPER LIMIT.” The font size is entered by selecting one from three option buttons respectively corresponding to the settings of “SMALL,” “STANDARD,” and “LARGE.”

When the entry of these settings is complete, a button “ENTER” is clicked.

When the entry of the user ID, etc. is complete, the mobile terminal 100 transmits the input user ID, etc. to the content delivery terminal 300. In step S114, the received user ID, etc. is registered in the user profile table 500, and the registered ID and password are issued to the mobile terminal 100.

Upon receiving the issued user ID and password, the mobile terminal 100 stores the user ID and password in an internal memory. When the user ID, which is attempted to be registered, is already registered, the user is requested to register a different user ID.

The digital content is now delivered to the user.

For example, when the user travels to Tokyo and finds the sights there, the user inputs “SIGHTS” as a search key on the mobile terminal 100, and transmits a content delivery request to the content delivery terminal 300. The mobile terminal 100 then automatically transmits the stored user ID and password along with the content delivery request.

Upon receiving the content delivery request, the user ID, and the password, the content delivery terminal 300 performs a user authentication process in step S204. When the user is authenticated, the content delivery terminal 300 acquires the position information of the mobile terminal 100 via the relay station 210, reads the hobby information and the preference information from the user profile table 500, searches for digital contents in the content registration DB 42 based on the acquired position information, and the read hobby information and preference information in steps S208-S212. The digital content relating to the present position of the user, and the hobby and preference of the user is now retrieved.

In steps S214-S218, the layout number is read from the user profile table 500, and the layout definition file corresponding to the read layout number is read from the user information registration DB 40 referencing the layout definition table 530. Based on the read layout definition file, the output layout for the retrieved digital content is determined, and the digital content is accordingly laid out.

In steps S220 and S222, the output terminal PR from which the user most appropriately receives the digital content is selected from the output terminals PR₁-PRₙ based on the acquired position information, and the retrieved digital content and the received user ID and password are transmitted to the selected output terminal PR (the output terminal PR₁, for example).

Upon receiving the retrieved digital content and user ID and password, the output terminal PR₁ stores the received digital content in the storage unit 62 with the user ID and password associated therewith in step S302.

When the user with the mobile terminal 100 enters a predetermined area of the output terminal PR₁ with the digital content stored in the output terminal PR₁ the short-range radio communication device in the mobile terminal 100 intermittently transmits a request for reply. As a result, in the predetermined area of the output terminal 100, the output terminal PR₁ receives the request for reply, and sends a reply to the mobile terminal 100. Upon receiving the reply, the mobile terminal 100 transmits the stored user ID and password to the output terminal PR₁ through short-range radio communication.

When the output terminal PR₁ receives the user ID and password through short-range radio communication, the output terminal PR₁ searches for user IDs and passwords in the storage unit 62 based on the received user ID and password. If there are present the user ID and password respectively corresponding to the received user ID and password, the output terminal PR₁ retrieves the digital content corresponding to the user ID and password and the retrieved digital content is printed out on the printer device 60 in step S406.

In this embodiment, the content delivery terminal 300 includes the user information registration DB 40 with the user information registered therewithin and the content registration DB 42 with the digital content registered therewithin. Upon receiving the content delivery request, the content delivery terminal 300 receives the position information of the mobile terminal 100 via the relay station 210, searches for the digital content in the content registration DB 42 based on the received position information and the user information in the user profile table 500, and then prints out the retrieved digital content on the output terminal PR.

In this way, the user is supplied with the digital content relating to the present position of the user or the destination of the user. Since the digital content is relatively closely related to the hobby and preference of the user, information, of the information relating to the destination of a travel which is much more needed by the user than that provided by the conventional art is delivered to the user.

In this embodiment, the content delivery terminal 300 selects the output terminal PR from which the user most appropriately receives the digital content, from among the output terminals PR₁-PRₙ, based on the position information, and the retrieved digital content is then transmitted to the selected output terminal PR.

Since the digital content is printed out on the output terminal PR from which the user of the mobile terminal 100 most appropriately receives the digital content, the user easily enjoys the digital content.

In this embodiment, the content delivery terminal 300 determines the output layout of the retrieved digital content based on the user information, and lays out the digital content accordingly.

Since the digital content is output in the output digital content relatively closely meeting the user's needs, the digital content is delivered in a layout to sea suitably by the user than in the conventional art.

In this embodiment, the output terminals PR₁-PRₙ hold information relating to the delivery request by the mobile terminal 100, out of the digital content received from the content delivery terminal 300, without outputting the information relating to the delivery request, until the mobile terminal 100 enters a predetermined area. The output terminals PR₁-PRₙ output the information relating to the delivery request by the mobile terminal 100, out of the digital contents received from the content delivery terminal 300, when the mobile terminal 100 enters the predetermined area.

Since the digital content is prevented from being printed out when the user is far from the output terminal PR, there is little possibility that the printout is lost or carried away by someone else before the user reaches the output terminal PR. The user thus reliably obtains the printed digital content.

In the above embodiment, the digital content corresponds to the data information stated in each of claims 1, 5, 6, 7, 9, 10 or 12, the user information registration DB 40 corresponds to the user information storage means stated in each of claims 1 or 12, the content registration DB 42 corresponds to the data information storage means stated in each of claims 1 or 12, and the relay station 210 corresponds to the position information acquisition means stated in each of claims 1 or 12. Step S212 corresponds to the data information selection means stated in each of claims 1, 5, 7, 10, or 12, step S220 corresponds to the output terminal selection means stated in each of claims 5, 6, or 10, and step S222 corresponds to the data information transmitter means stated in each of claims 5 or 10. Step S218 corresponds to the layout means stated in claim 7, step S300 corresponds to the first user information receiver means stated in claim 10, and step S400 corresponds to the second user information receiver means stated in claim 10.

In the above embodiment, the user information registration DB 40 is arranged in the content delivery terminal 300. Alternatively, the user information registration DB 40 may be arranged in the mobile terminal 100.

From the standpoint of security, all user information is preferably stored in the mobile terminal 100. However, if all user information is stored there, most of the memory of the mobile terminal 100 may be occupied by the user information. In view of the efficiency of memory and the enhancement of security, more preferably, the user ID and password requiring confidentiality are stored in the mobile terminal 100, and the user information requiring no such confidentiality is stored in the content delivery terminal 300. The user information requiring no such confidentiality may be stored in a network terminal rather than in the content delivery terminal 300, and the content delivery terminal 300 may retrieve the user information from the network terminal.

When the user information in part or whole is stored in the mobile terminal 100, from the standpoint of security, the mobile terminal 100 stores the user information associated with security information, and preferably determines the mode of transmission of the user information based on the security information. For example, when the user information corresponding to the security information at a relatively high security level is transmitted, the user is asked whether to transmit the user information. When the data information at a standard security level is transmitted, the user is notified of the content of the user information to be transmitted. When the data information at a low security level is transmitted, the user information is directly transmitted without checking with the user.

In the above embodiment, the user information is stored in the content delivery terminal 300. The present invention is not limited to this arrangement. When user information in part or whole may be stored in a storage medium from which the mobile terminal 100 reads the user information. For example, the user information may be stored in an IC card with which the mobile terminal 100 exchanges information. If the IC card is unloaded, and inserted into a different mobile terminal, the different mobile terminal can use the same user information.

In the above embodiment, the content registration DB 42 is arranged in the content delivery terminal 300. Alternatively, the content registration DB 42 may be arranged in another network terminal, and the content delivery terminal 300 may acquire the digital content from that network terminal as necessary.

In the above embodiment, the position information of the mobile terminal 100 may be acquired through the relay station 210. Alternatively, the mobile terminal 100 may acquire the position information of its own. In this case, the mobile terminal 100 acquires position information using the GPS by position fixing.

In the above embodiment, the output terminal PR receives the user ID and password from the mobile terminal 100, and searches for the digital content corresponding to the received user ID and password in the digital contents stored in the storage unit 62, in accordance with the received user ID and password. From the standpoint of enhancing security, encryption techniques are preferably employed in communications between the mobile terminal 100 and the output terminal PR. Specifically, the mobile terminal 100 employs the RSA encryption to send the user ID and password to the output terminal PR. In this case, the private key is held in the user profile in the mobile terminal 100, and the public key only is transferred through the content delivery terminal 300 to the output terminal PR. Using the two keys, the user is authenticated. The public key only is transferred, eliminating the need for unnecessarily communicating the private key to the outside, and thereby enhancing security.

In the above embodiment, the output terminal PR prints out the digital content when the mobile terminal 100 enters the predetermined area. Alternatively, the predetermined area is calculated accounting for the time required for the printing so that printing is completed at or slightly prior to the moment the user reaches the output terminal PR, and when the mobile terminal 100 enters the calculated predetermined range, the digital content is printed out.

In the above embodiment, the digital content is searched for in the content registration DB 42, based on the position information, the hobby information and the preference information. The present invention is not limited to this arrangement. Searching may be performed accounting for time information. For example, when it is currently at midnight, information about stores which are open at midnight is searched for with priority. When it is currently in spring, sights appropriate for cherry blossom viewing are searched for with priority.

In the above embodiment, the present invention is applied with the mobile terminal 100 used as a mobile telephone or a PDA. Alternatively, the mobile terminal 100 may be used for a car navigation system. For example, the mobile terminal 100 may be used for a car navigation system incorporating an ITS (Intelligent Transport System) or a car navigation system having the function of mobile telephone and connectable to the Internet 400. By incorporating the information providing system into a system closely cooperating with the ITS, traffic information may be used on a real time basis. For example, routing information may be generated so that sightseeing at a traffic congestion affected spot is deselected. A smooth traffic route may be selected when routing information to places (such as stores or sights) is included in information to the user.

In the above embodiment, the output terminal PR is constructed to print out the digital content from the content delivery terminal 300. The present invention is not limited to this arrangement. The digital content may be output in sound or may be visually presented on a display.

In the above embodiment, the output terminal PR is arranged to print out the digital content. However, when the digital content is output in sound, the mobile terminal 100, rather than the output terminal PR, may be used.

In the above-referenced embodiment, the process shown in the flow diagrams in FIG. 5, FIG. 6, FIG. 8, and FIG. 9 is performed by executing a control program stored beforehand in the ROM 32 and ROM 52. The present invention is not limited to this. Before being executed, the process may be performed by reading, from a storage medium, a software program of the process into the RAM 34 and RAM 54.

The storage medium may be a semiconductor storage medium such as an RAM, an ROM, etc, a magnetic storage medium such as an FD, an HD, etc, an optical storage medium such as a CD, a CDV, an LD, a DVD, etc., or a magneto optical storage medium such as an MO, etc. The storage medium is thus any computer readable storage medium that permits data to be read electronically, magnetically, or optically.

In the above embodiment, the information providing system, the output terminal, the mobile terminal, and the storage medium of the present invention are implemented in a network system such as the Internet 400. The present invention is not limited to this arrangement. Alternatively, the present invention may be applied to a so-called intranet that performs the same communication as that of the Internet 400. The present invention is not limited to a network that performs the same communication method as that of the Internet 400, and may be applied to an ordinary network.

In above embodiment, the information providing system, the output terminal, the mobile terminal, and the storage medium of the present invention are arranged as shown in FIG. 1. The mobile terminal 100, and the content delivery terminal 300 communicably connected to the output terminals PR₁-PRₙ select a digital content from among the digital contents acquired from the content storage terminals DS₁-DSₘ in response to the content delivery request by the user, and output the selected digital content to the optimum output terminal among the output terminals PR₁-PRₙ. The present invention is not limited to this arrangement, and may be applied to other system configuration without departing from the scope and spirit of the present invention.

As described above, the information providing system of the present invention according to each of claims 1 through 8 provides the user with information much needed by the user, of the information relating to the area of the destination of a travel, in comparison with the conventional art.

In the information providing system of the present invention according to each of claims 5 and 6, the output terminal, from which the user most appropriately receives the data information, outputs the data information, the user is easily supplied with the data information.

In the information providing system of the present invention according to claim 7, the digital content relatively closely meeting the needs of the user is output. The digital content thus delivered to the user is easy to see in comparison with the conventional art.

In the information providing system of the present invention according to claim 8, the security of the user information is enhanced.

In addition to the advantages of the information providing system of claim 1, the output terminal of the present invention according to one of claims 9 and 10 prevents the data information from being output when the user is far from the output terminal. The user can thus reliably obtain the output data information.

In addition to the advantages of the information providing system of claim 1, the mobile terminal of the present invention as recited in claim 11 enhances security of the user information.

The storage medium of the present invention as recited in claim 12 storing the information providing program presents the same advantage as that of the information providing system of claim 1.

What is claimed is:

1. An information providing system, communicably connected to a mobile terminal, for providing a user of the mobile terminal with information, comprising:
user information storage means for storing user information relating to the user, data information storage means for storing data information to be provided, position information acquisition means for acquiring position information determining a position of the mobile terminal, and data information selection means for selecting the data information in the data information storage means, based on the user information in the user information storage means and the position information acquired by the position information acquisition means.

2. An information providing system, communicably connected to a mobile terminal containing user information storage means for storing user information relating to a user, for providing the user of the mobile terminal with information when the user information is received from the mobile terminal, the information providing system comprising:
data information storage means for storing data information to be provided, position information acquisition means for acquiring position information determining a position of the mobile terminal, and data information selection means for selecting the data information in the data information storage means, based on the user information from the mobile terminal and the position information acquired by the position information acquisition means.

3. An information providing system, communicably connected to a mobile terminal containing user information storage means for storing user information relating to a user and position information acquisition means for acquiring position information determining a position of the mobile terminal, for providing the user of the mobile terminal with information when the user information and the position information are received from the mobile terminal, the information providing system comprising:
data information storage means for storing data information to be provided, and data information selection means for selecting the data information in the data information storage means, based on the user information and the position information from the mobile terminal.

4. An information providing system, which is communicably connected to a mobile terminal containing user information storage means for storing user information relating to a user and position information acquisition means for acquiring position information determining a position of the mobile terminal, and which is communicably connected to a information storage terminal containing data information storage means for storing a plurality of pieces of data information to be provided, wherein the information providing system provides the user of the mobile terminal with information when the user information and the position information are received from the mobile terminal, and
wherein the information providing system comprises data information selection means for selecting the data information in the data information storage means, through communication with the information storage terminal based on the user information and the position information from the mobile terminal.

5. An information providing system according to one of claims 1 through 4, communicably connected to a plurality of output terminals for outputting data information, comprising:
output terminal selection means for selecting, from among the plurality of output terminals, an output terminal from which the user most appropriately receives the data information, and data information transmitter means for transmitting the data information, selected by the data information selection means, to the output terminal selected by the output terminal selection means.

6. An information providing system according to claim 5, wherein the output terminal selection means selects, from among the plurality of output terminals, the output terminal from which the user most appropriately receives the data information, based on at least one of the user information and the position information.

7. An information providing system according to one of claims 1 through 6, wherein the data information is a digital content, and
wherein the information providing system comprises content layout means for determining an output layout of a digital content which is selected by the data information selection means in accordance with the user information, and for laying out the digital content in accordance with the output layout.

8. An information providing system according to claim 1, wherein the user information storage means comprises first user information storage means for storing the user information that requires confidentiality, and second user information storage means for storing the rest of the user information, and
wherein the mobile terminal comprises the first user information storage means.

9. An output terminal communicably connected to the information providing system according to one of claims 5 and 6,
wherein the output terminal holds information relating to a delivery request by the mobile terminal, of the data information received from the information providing system, without outputting the information relating to the delivery request, until the mobile terminal enters a predetermined area, and outputs the information relating to the delivery request by the mobile terminal, of the data information received from the information providing system, when the mobile terminal enters the predetermined area.

10. An output terminal according claim 9, wherein the data information transmitter means transmits the data information selected, by the data information selection means, and the user information, to the output terminal selected by the output terminal selection means,
wherein the output terminal comprises first user information receiver means for receiving the data information and the user information from the information providing system, and second user information receiver means for receiving the user information from the mobile terminal, and
wherein when the second user information receiver means receives the user information, the user information received by the first user information receiver means is matched against the user information received by the second user information receiver means, and when these pieces of user information satisfy a predetermined relationship, the data information received by the first user information receiver means is output.

11. A mobile terminal communicably connected to an information providing system according to one of claims 2 and 3, comprising:
user information storage means for storing the user information relating to the user with security information associated the user information, and transmission mode determining means for determining a transmission mode of the user information based on the security information in the user information storage means.

12. A computer readable storage medium, communicably connected to a mobile terminal, storing an information providing software program for providing a user of the mobile terminal with information, wherein the software program for a process carried out by position information acquisition means for acquiring position information determining a position of the mobile terminal, and data information selection means for selecting data information in the data information storage means, based on the user information in the user information storage means, and the position information acquired by the position information acquisition means, is performed by a computer comprising user information storage means for storing user information relating to the user, and data information storage means for storing the data information to be provided.
